(19) United States
(12) Patent Application Publication
(10) Pub. No.: US 2006/0212809 A1
(43) Pub. Date: Sep. 21, 2006

(54) Electronic device capable of displaying an instruction manual

(76) Inventor: Shintaro Oshima, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/378,167

(22) Filed: Mar. 17, 2006

(30) Foreign Application Priority Data
Mar. 17, 2005 (JP) 2005-077669

(51) Int. Cl. G06F 17/00

(52) U.S. Cl. 715/526; 715/530

(57) ABSTRACT

An electronic device such as a digital still camera enables display of an instruction manual and providing explanations of a variety of functions and operations to the user. Specifically, the electronic device has a storage unit that stores instruction manual data and a display control unit that reads instruction manual electronic data from the storage means and displays the instruction manual on a display device. Further, the electronic device has an editor that is capable of editing the instruction manual displayed on the display device and a control member for operating the display control unit and the editor, making it possible to edit the instruction manual electronic data according to the way each user uses the camera, their level of skill and experience, in order to make the instruction manual easier to use.

### FIELD OF THE INVENTION

The present invention relates to an electronic device comprising storage device that stores instruction manual data, a method of editing the instruction manual image using the electronic device, and a computer program therefor.

### BACKGROUND OF THE INVENTION

In general, an instruction manual for using an electronic device or the like is usually provided as printed material separate from the device itself or its accessories.

Recently, however, with the spread of personal computers (PCs), it is becoming more common to distribute material in an ordinary electronic file format such as PDF (Portable Data Format). At present, it is not uncommon for the instruction manual for the electronic device to be provided in just such an electronic file format, in other words, as an electronic instruction manual. However, such an electronic file is ultimately intended for use on a PC.

As a result, an electronic instruction manual is not so convenient for use with devices other than PCs except for its space-saving nature in case where the printed manual is too bulky to carry or the manual is to be retained.

In addition, when using electronic devices that place a premium on portability, such as digital cameras and digital video cameras and the like, it is often the case that, in addition to the device itself, the user carries around peripherals such as chargers, cables and so forth. As a result, considering the portability of the device and the frequency with which it is used, most users do not usually carry the printed instruction manual with them.

At the same time, electronic devices have become more complicated and more powerful, and it is not easy to remember perfectly all the functions and how they are used. Therefore, without the instruction manual, not only is it not possible to use the device to its fullest potential, but in some cases it is even possible that the device itself might be damaged. As a result, a variety of proposals have been made in an effort to avoid this sort of trouble, such as incorporating into the electronic device a help or guidance function that explains how to use the device or using an electronic instruction manual. However, virtually all these proposals are intended to complement the instruction manual provided as printed material.

Japanese Patent Application Laid-Open No. 5-216106 proposes a help/guidance function to be used instead of the conventional instruction manual, which displays such information as how to operate the device, an explanation of the functions and so forth on the display unit of the camera itself or of a detachable accessory. Specifically, the proposal calls for operating control members of the camera or the accessory to enable display of information about the photo or explanations of the functions.

In addition, storing a portion of the instruction manual as electronic data in a detachable external storage medium that records digital camera image data and reading out and displaying that data on the display means of the device itself when needed has also been proposed (Japanese Patent Application Laid-Open No. 2003-87628). In this proposal, it is assumed that the instruction manual electronic data stored in the external storage medium can be displayed on the device display means. However, that which is stored as electronic data is limited to functions that can be added to the camera control program later.

Japanese Patent Application Laid-Open No. 5-216106 involves displaying operation guidance linked to the detection of operation of control members provided on the camera, and as a result ultimately constitutes no more than passive guidance display linked to operations that are limited to when the user shoots, and thus merely complementing the instruction manual. In short, the capabilities and explanations thus disclosed are insufficient to convey such information as basic operation and settings, operations and settings not linked to the control members, troubleshooting, and the knowledge and skill to use a camera in a wide range of circumstances.

Similarly, in Japanese Patent Application Laid-Open No. 2003-87628, the instruction manual capable of being displayed on the camera is limited to functions which can be added later to the camera control program, and as a result, the capabilities and explanations thus disclosed are insufficient to convey such information as basic operation and settings, operations and settings not linked to the control members, troubleshooting, and the knowledge and skill to use a camera in a wide range of circumstances.

Furthermore, conventionally, there has been no proposal to provide the capacity to allow the user himself to use the electronic device and edit and customize the instruction manual in light of that experience of use.

### SUMMARY OF THE INVENTION

The present invention is conceived in light of the problems of the conventional art described above, and has as its object to provide an electronic device that is capable of providing the user with more complete information on the basic operations and capabilities of the electronic device even without constantly carrying around the instruction manual with the device.

According to an aspect of the present invention, there is provided an electronic device comprising: storage unit adapted to store instruction manual data; display control unit adapted to read instruction manual data from the storage unit and displaying an instruction manual on a display device; editing unit being capable of editing the instruction manual displayed on the display device; and operating unit adapted to operate the display control unit and the editing unit.

According to another aspect of the present invention, there is provided an instruction manual editing method using an electronic device having storage means for storing instruction manual data, the electronic device reading the instruction manual data from the storage means and displaying the instruction manual on a display device in response to an operation of an operating means, and editing the instruction manual displayed on the display device in response to the operation of the operating means.

According to yet another aspect of the present invention, there is provide a computer program used in an electronic device having storage means for storing instruction manual data, the computer program causing a computer to execute: a display process of reading instruction manual data from the storage means and displaying the instruction manual on a display device in response to an operation of an operating means; and an editing process of editing the instruction manual displayed on the display device in response to the operation of the operating means.

With the above-described construction, the electronic device of the present invention makes it possible to provide the user with more complete information on the basic operations and capabilities of the electronic device even without constantly carrying around the instruction manual with the device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic internal structure of a digital still camera according to an embodiment of the present invention;

FIG. 2 is a diagram showing a front perspective view of the digital still camera according to an embodiment of the present invention;

FIG. 3 is a diagram showing a rear view of the digital still camera according to an embodiment of the present invention;

FIG. 4 is a flow chart illustrating shifting to various modes of the digital still camera according to an embodiment of the present invention;

FIG. 5 is a diagram showing a state in which a portion of the table of contents of the instruction manual is displayed;

FIG. 6 is a diagram showing a state in which a portion of the contents of the instruction manual is displayed;

FIG. 7 is a diagram showing a state in which a portion of the table of contents of the instruction manual is displayed;

FIG. 8 is a diagram showing a state in which enlarged display is selected for the display shown in FIG. 7;

FIG. 9 is a diagram showing a state in which a portion of the contents of the instruction manual is displayed;

FIG. 10 is a diagram showing a state in which a portion of the contents of the instruction manual is displayed; and

FIG. 11 is a diagram showing a state in which a portion of the contents of the instruction manual is displayed.

### DETAILED DESCRIPTION OF THE PREFERRED EMBODIMENTS

Preferred embodiments of the present invention will now be described in detail in accordance with the accompanying drawings.

In the present embodiment, a description is given of an arrangement in which the present invention is adapted to a digital still camera. However, the present invention can also be adapted to electronic devices other than a digital still camera.

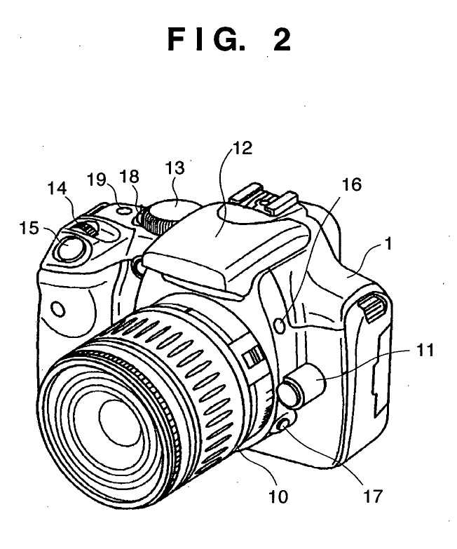

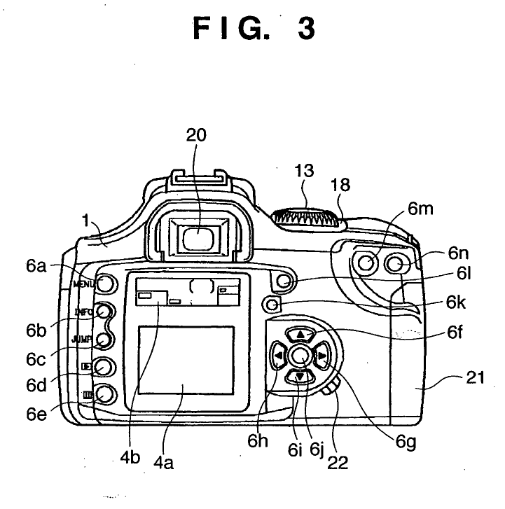

FIGS. 2 and 3 show external views of the digital still camera of the present embodiment. Reference numeral 1 designates the camera and 10 designates a detachable photographic lens that can be mounted on and detached from the camera 1, and is one type of what is herein referred to as an accessory.

Reference numeral 11 designates a lens release button for detaching the lens 10 from the camera 1. Reference numeral 12 designates a built-in strobe, in a closed state in which it is retracted onto the camera 1. Reference numeral 13 designates a mode dial for switching between several photographic modes. Reference numeral 14 designates an electronic dial for inputting various values such as shutter speed and f-stop.

Reference numeral 15 designates a two-stage release button for starting focusing and for releasing the shutter. Pressing the release button 15 lightly to a first stage is referred to herein as “pressing halfway”. In this state, focusing is carried out. Pressing further to a second stage after pressing halfway is referred to herein as “pressing fully”. In this state, a shutter device and an image-sensing element (not shown) inside the camera 1 operate and exposure is carried out.

Reference numeral 16 designates a built-in strobe button for using the built-in strobe 12. When the built-in strobe button 16 is pressed, the built-in strobe 12 opens from the closed state shown in the diagram to a position at which the optical axis of the strobe flash is substantially parallel to the optical axis of the photographic lens 10.

Reference numeral 17 designates a depth-of-field preview button, which moves a diaphragm device built into the photographic lens 10 until a light level that corresponds to the f-stop set at that time is reached, and enables the user to check the depth of field of the target subject by looking through a viewfinder to be described later.

Reference numeral 18 designates a main switch for switching the digital still camera between operable and non-operable, and 19 designates a self-timer button for using a self-timer built into the digital still camera.

Reference numeral 4a designates a display device for displaying digital still camera settings and a photographed image, and is comprised of a dot matrix-like LCD (liquid crystal display) monitor capable of color display of displayable instruction manual electronic data.

Reference numeral 4b designates an external liquid crystal display unit composed of a liquid crystal display member for continuously displaying the state of the digital still camera settings, the number of exposures made, the amount of remaining battery capacity and the like.

Reference numerals 6a-6n designate a plurality of operating members for operating the digital still camera, and correspond to what is referred to as operating means in the invention. Reference numeral 6a designates a menu button, which displays menu items in which a variety of functions are divided by item, such as the settings used when photographing, the settings used when playing back a photographed image, and other initial settings of the camera. When the menu button 6a is pressed, the camera enters a state in which it is possible to change the settings (hereinafter referred to as a “menu mode”). The basic operation of the camera involves using the operating members while looking at the display device 4a. In addition, a state in which normal photographic operation is possible or a state in which photography is being carried out is referred to as a “photography mode”.

Reference numeral 6f designates an up cross key, 6g designates a right cross key, 6h designates a left cross key, and 6i designates a down cross key. In the menu mode it is possible to select a menu item displayed on the display device 4a in response to the operation of the cross keys 6f-6i. Reference numeral 6j designates a set button for setting that which is selected by the operation of the cross keys 6f-6i.

Reference numeral 6d designates a playback button. When the playback button 6d is pressed, the image photographed last is displayed on the display device 4a. This state is called the playback mode. Reference numeral 6c designates a jump button. When the jump button 6c is pressed during playback, the image displayed on the display device 4a jumps to another image to be displayed.

Reference numeral 6b designates an information button. When the information button is pressed during playback mode, photographic information about the image that is displayed on the display device 4a is displayed. In addition, when the information button 6b is pressed in preparation for shooting a picture in the photography mode, what is selected in the current menu mode is displayed on the display device 4a.

Reference numeral 6e designates a delete button. When the delete button 6e is pressed in a state in which the playback button is pressed and an image is displayed, the image can be deleted. Reference numeral 6l designates an exposure compensation button, which performs exposure compensation in combination with the electronic dial during photography and sets the photographic lens 10 f-stop.

Reference numeral 6k designates an illumination button, lighting the backlight of the external liquid crystal display unit 4b. Reference numeral 6m is an AF frame switching button. By turning the electronic dial 14 after pressing the AF frame switching button 6n during photography, the focus of the auto focus can be switched.

Reference numeral 20 designates a viewfinder for checking the photographic target subject. Reference numeral 21 designates a memory container for holding a detachable memory card, not shown, in the camera. Reference numeral 22 designates an access indicator unit, indicating when the camera 1 is accessing the memory card, and is equipped with an internal LED device.

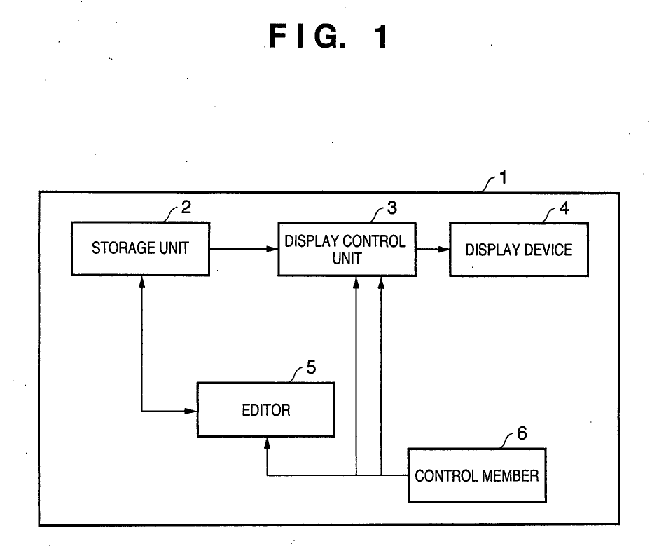

FIG. 1 is a block diagram showing the schematic internal structure of the digital still camera described above. Constituent elements that are similar or identical to those described in FIGS. 2 and 3 are given the same reference numerals and a description thereof is omitted. In FIG. 1, reference numeral 1 designates the camera.

Reference numeral 2 designates a storage unit, which is a non-volatile memory having space in which photographed image data is recorded as well as space in which to store instruction manual electronic data. The storage unit 2 may be a detachable recording medium such as a memory card or the like.

Reference numeral 3 designates a display control unit that reads the instruction manual electronic data stored in the storage unit 2 in addition to the image data and photography data stored therein and displays the data in a display unit 4.

Reference numeral 4 designates the display unit. In this case, the display unit 4 is the display device 4a, which is one of the two types of display devices 4a, 4b shown in FIG. 3 and comprises color dot matrix-like LCD (liquid crystal display) or other such monitor.

Reference numeral 5 designates an editor capable of editing the instruction manual electronic data within a predetermined range. What the editor 5 can edit is described later.

Reference numeral 6 designates a plurality of operating members for operating the digital still camera, consisting of push-type on/off buttons for carrying out various settings and operations of the camera, rotary-type dial operating members, levers, slides and so forth.

The editor 5, using operations to be described later employing the operating members 6, edits the instruction manual electronic data within a predetermined range while displaying on the display unit 4 the instruction manual electronic data stored in the storage unit 2 through the display control unit 3. The edited instruction manual image data is then once again stored in the storage unit 2, enabling the edited instruction manual to be displayed on the display unit 4 starting with the next display.

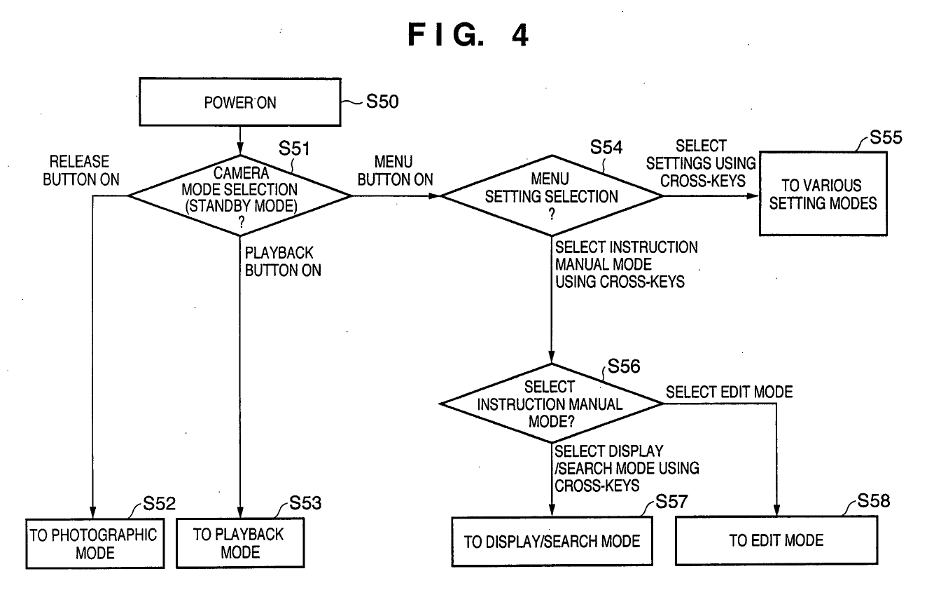

FIG. 4 is a flow chart illustrating shifting to various modes of the digital still camera according to the present embodiment. In step S50, the camera power is switched ON. Step S51 shows a state immediately after the camera power has been switched on, that is, a standby mode in which it is possible to select any of the camera modes described above.

When the release button 15 is switched on from the standby state of step S51, the camera shifts to the photography mode of step S52 and a photography sequence is carried out. When the predetermined photography sequence is finished, the camera returns to the standby mode of step S51.

When the playback button 6d is pressed from the standby mode S51, the camera shifts to the playback mode of step S53. In the playback mode, a photographed image is displayed on the display unit 4 in accordance with instructions from the user, or an image search is carried out. In addition, by operating the operating members 6, the user can freely select a photographed image and display a single image or image information, an index, an enlarged zoom-up, and the like.

When the menu button 6a is switched on from the standby state in step S51, the camera shifts to the menu setting selection state in step S54 and displays on the display unit 4 menu items in which the various functions of the camera are divided into separate items, such as the settings used during photography, the settings used when playing back the photographed images, and other initial camera settings. By operating the cross-keys 6f-6i and the set button 6j from this state, the camera can be shifted to the setting modes of step S55.

By selecting the instruction manual mode set among the menu items during the menu setting selection of step S54, the camera can be shifted to the instruction manual mode of step S56. In step S56, it is possible to shift further to a display/search mode of step S57 or to an edit mode of step S58. It should be noted that the display/search mode simply displays the instruction manual or searches the contents of the instruction manual, whereas the edit mode also edits the contents of the instruction manual.

In any of the states of steps S53, 54, 55, 56, 57, 58, the release button can be operated at any time. If the release button is operated, then previous operations are cancelled and the camera can jump to the photography mode of step S52.

It should be noted that, in this case, it is assumed that the shift to the display/search mode requires going through the menu setting of step S54 and the instruction manual mode of step S56. However, in an effort to simplify operation, a short-cut function for jumping to step S57 from the standby mode of step S51 may be allocated to one of the operating members 6 (for example, the jump button 6c).

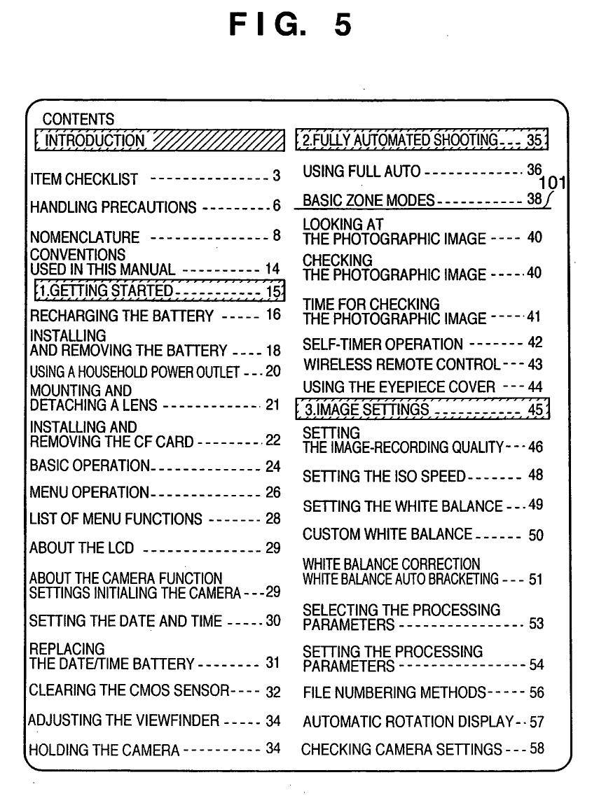

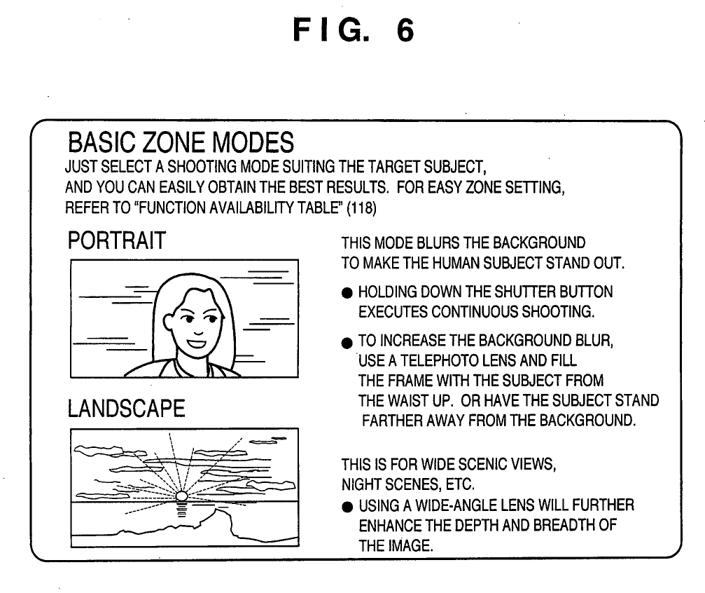

An example of a display on the display unit 4 when the camera is shifted to the display/search mode of step S57 is shown in FIGS. 5 and 6. FIG. 5 shows a state in which a portion of the table of contents of the instruction manual is displayed. Shifting to the subheadings of the headings shown in FIG. 5 can be accomplished by operating the cross-keys 6f-6i. The example shown in the diagram shows a state in which the underline 101, which indicates the selection position, is moved to the subheading “Basic Zone Modes . . . 38” of the heading “2 Fully Automatic Shooting”. It should be noted that although in the example shown in the diagram the selection position is shown by the underline 101, since the display device 4a is a color display the selection position can be shown, for example, by changing the color of the characters.

By pressing the set button 6j in the state show in FIG. 5, it is possible to switch the display to the selected subheading item page. FIG. 6 shows a state in which a portion of the page “Basic Zone Modes . . . 38” selected by the underline 101 shown in FIG. 5 is displayed.

It should be noted that although that which is displayed in FIGS. 5 and 6 is virtually identical to the paper instruction manual that is provided as printed material conventionally, the amount of information that can be displayed on a single screen varies with the size and the resolution of the display screen of the display device 4a. As a result, it is not necessary that the character font, size and type, and the size and layout of images and illustrations of the instruction manual as displayed are exactly the same as the printed instruction manual.

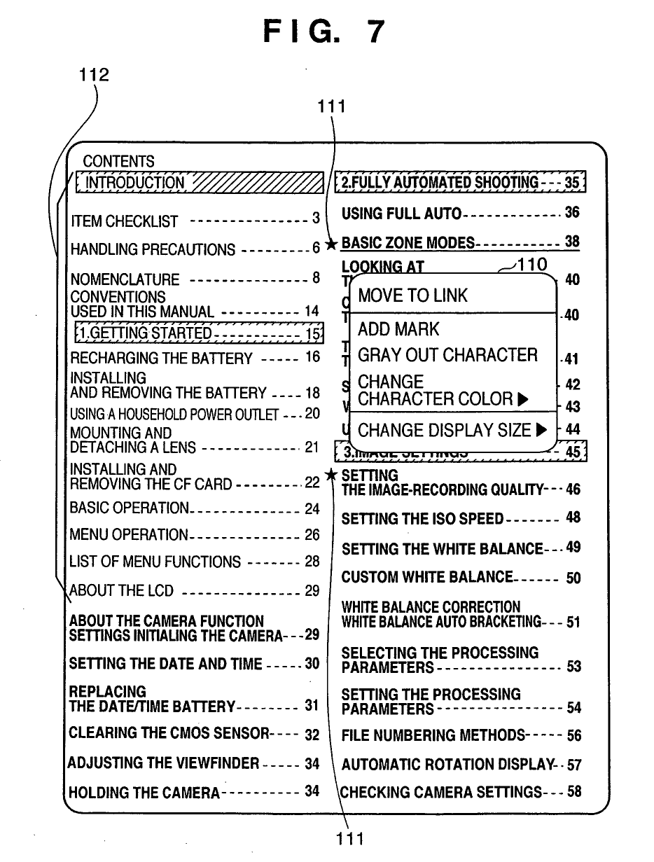

An example of a display of the display unit 4 in a state in which the camera has shifted to the edit mode of step S58 show in FIG. 4 is shown in FIG. 7. Like FIG. 5, FIG. 7 shows a state in which a portion of the table of contents of the instruction manual is displayed. In FIG. 7, shifting to the subheadings of the headings can be accomplished by operating the cross-keys 6f-6i. If the set button 6j is then pressed after shifting to the subheading “Basic Zone Modes . . . 38” of the heading “2 Fully Automatic Shooting” as described with respect to FIG. 5, a pop-up menu 110 is displayed on the display unit 4.

By further operating the cross-keys 6j or 6i in the state shown in FIG. 7, an item on the pop-up menu 110 can be executed. For example, pressing the set button 6j once more after selecting the “move to link” item at the top of the pop-up menu 110 enables shifting to the state shown in FIG. 6. In other words, the display can be shifted to a state in which a portion of the page “Basic Zone Modes . . . 38” is displayed on the display device 4a.

In addition, from the state shown in FIG. 7, pressing the set button 6j once more after selecting the “add mark” item in the second line of the pop-up menu 110 enables the user to add a mark 11 (shown in the example as a star ★) for the purpose of indexing the first part of the selected item.

In addition, from the state shown in FIG. 7, pressing the set button 6j once more after selecting the “gray-out characters” item in the third line of the pop-up menu 110 enables the color of the character strings of the selected items to be changed to gray. It should be noted that, although it may be difficult to see in FIG. 7, the color of the character strings of the items in a range 112 has been changed to gray.

In addition, from the state shown in FIG. 7, pressing the set button 6j once more after selecting the “change character color” item in the fourth line of the pop-up menu 110 causes a color selection menu, not shown, to appear. The color selection menu may be another pop-up menu, or another menu may be displayed. By selecting a predetermined color from the color selection menu and pressing the set button 6j, the color of the character strings of the selected items can be changed to the selected color.

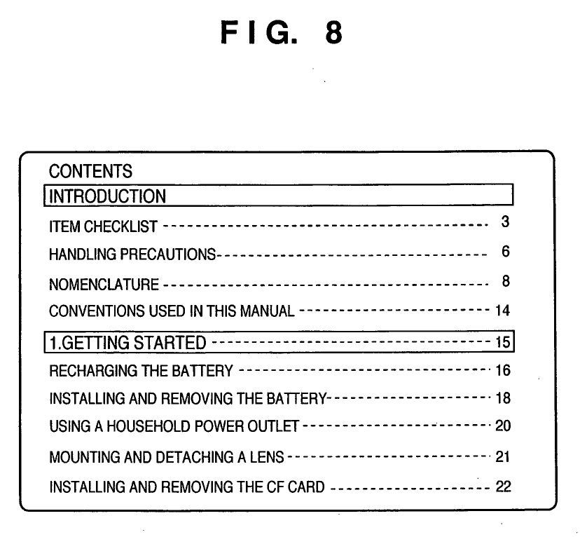

Similarly, from the state shown in FIG. 7, pressing the set button 6j once more after selecting the “change display size” item in the fifth line of the pop-up menu 110 enables the display size to be changed. Specifically, a further pop-up menu, not shown, appears, allowing the user to designate enlargement or reduction of the display size. FIG. 8 shows an example in which the display shown in FIG. 7 is enlarged, showing an enlarged display of a portion of the table of contents of the instruction manual.

In the present embodiment, it is assumed that the customization of the instruction manual described above is carried out in the edit mode of step S58 shown in FIG. 4. However, matters may be arranged so that such functions as, for example, “add mark” and “change display size”, can be set even in the display/search mode of step S57.

Moreover, for that which cannot be edited, the selection of functions is not limited to “add mark”, “gray-out characters”, “change character color” and the like but may also include such functions as changing the font of the selected character string or item.

In addition, it is also possible to make sections of the instruction manual electronic data selectable in units of character strings or items, with the selected units of character strings or items then able to be non-displayed or the electronic data of the units of character strings or items able to be deleted from the storage unit 2.

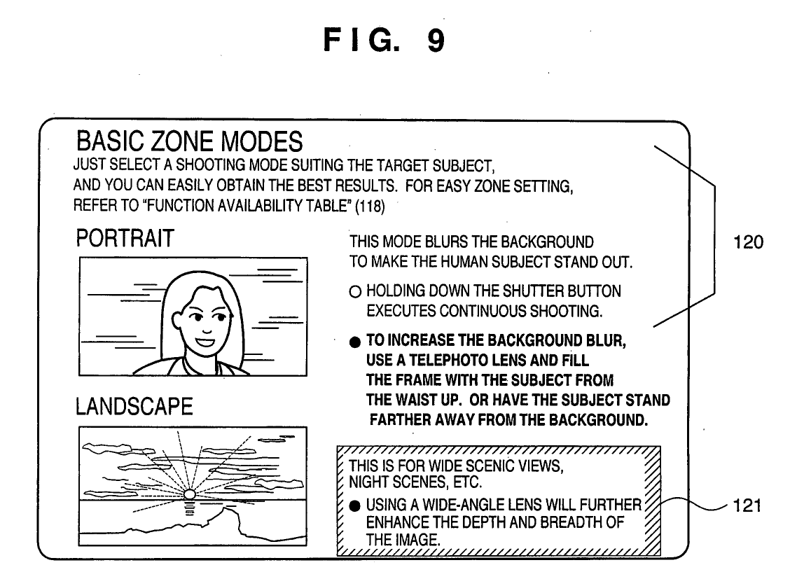

FIG. 9 shows a state in which a portion of the page “Basic Zone Modes . . . 38” shown in FIG. 6 is displayed, but with editing. Specifically, in a range 120, by the application of the “gray-out characters” function of the edit mode described with reference to FIG. 7, the character strings of a portion of the instruction manual has been made difficult to see. Although it may be difficult to see in FIG. 9, the color of a portion of the character strings in the range 120 has been changed to gray. In addition, in a range 121, the background color of the characters has been changed as one function expansion of the “change character color” function of the edit mode.

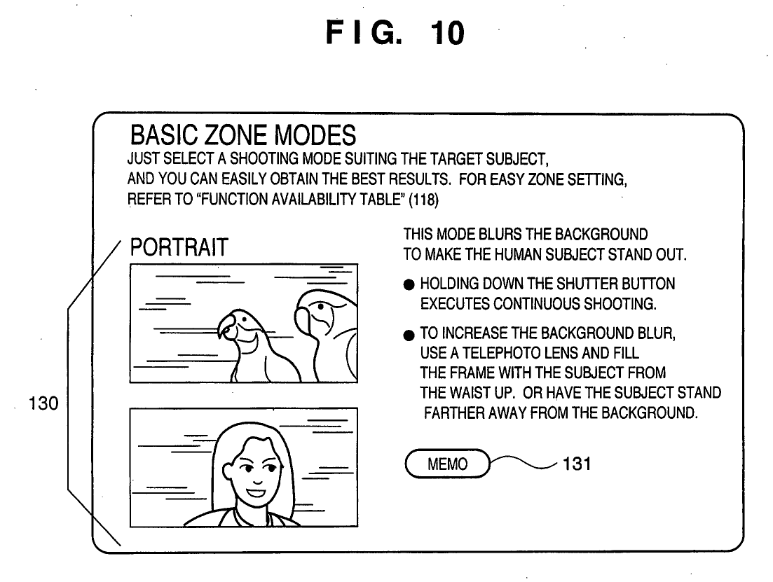

FIG. 10, like FIG. 9, shows a state in which a portion of the page “Basic Zone Modes . . . 38” shown in FIG. 6 is displayed. However, whereas in FIG. 9 only one example of a picture in the portrait mode is shown, FIG. 10 shows an example of a state in which two pictures 130 are shown under the portrait mode. The user may himself choose from among a plurality of different types of data for the sample picture images may be prepared in advance as a portion of the instruction manual electronic data. Alternatively, matters may be arranged so that it is possible to add an image or images that the user has photographed himself as sample pictures.

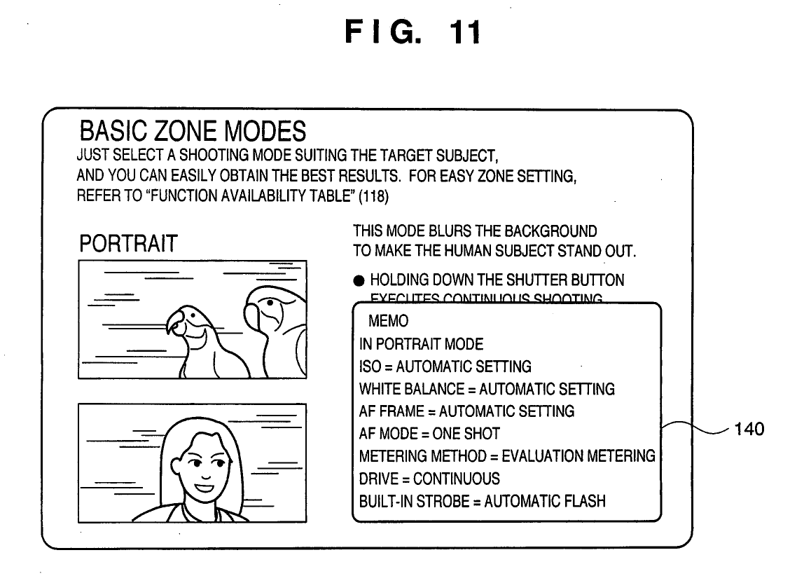

In addition, a “to memo” item 131 is an icon for adding, for example, comments that the user himself wishes to note with respect to a particular subheading of the instruction manual. In this case, for example, the preset icon 131 shown in the diagram is selectable, and moreover, is added at a predetermined position. By operating the cross-keys 6j and 6i to select this icon and by pressing the set button 6j once more, the user can display a memo 140 like the example shown in FIG. 11.

There is no particular limitation on the method used to add the character strings (sentences) of the memo 140. However, the digital still camera of the present embodiment is not usually equipped with an input device such as the keyboard of a personal computer. As a result, for example, text data created in advance using a personal computer using a predetermined format can be read into the camera. As methods for transferring such text data, there is a method involving storing the text data in the detachable storage unit 2 installed in the camera 1 and the text data then read in, as well as a method involving communicably connecting the camera 1 and a personal computer by wire or wireless connections and transferring the data over the wire or wireless connections.

Although the present embodiment is described using an example in which the instruction manual as well as the instructions and the text that appear in response to various operations are in Japanese, depending on the camera setting it is possible to set the display to such languages as English, French, Spanish, Chinese and so forth.

Thus, as described above, the present embodiment eliminates the need always to carry the instruction manual about and enables the user to check how to operate the camera and to refer to information on the various functions of the camera immediately and with ease. Further, the present embodiment can provide detailed information on such matters as basic operation and settings, operations and settings not linked to the operating members, troubleshooting, and wide-ranging expertise and advice regarding the operation of electronic devices.

Moreover, the present embodiment allows editing of the instruction manual electronic data according to the way each user uses the camera and their level of skill and experience, in order to make the instruction manual easier to use.

For example, by enabling a mark to be added to a character string or an item for the purpose of indexing such character string or item, the present embodiment makes it possible to edit the instruction manual into something that allows the user to look up important items quickly and that is easy to use. In addition, by enabling the form in which a character string or an item is displayed to be changed, the present embodiment not only makes it possible for the user to look up important items quickly but also makes the instruction manual into something that is easy to read and easy to use. Also, by making it possible to delete unneeded character strings and items, the present embodiment not only makes it possible for the user to look up important items quickly but also makes the instruction manual into something that is easy to read and easy to use. Moreover, by making it possible for the user to add or to change sample picture images in the instruction manual, the present embodiment makes it possible to make the instruction manual into something that is easy to understand and easy to use. In addition, by making it possible to add newly created character strings, the present embodiment enables each individual user to add comments and information as memos, making it possible to make the instruction manual into something that is easy to use. Thus, as described above, the electronic instruction manual can be edited and customized on the electronic device itself, enabling the present embodiment to provide an electronic instruction manual that can be edited according to the way each user uses the camera, their level of skill and experience, and thus is easy to use.

It should be noted that the above-described invention can also be implemented as software by a system or apparatus having a computer (or CPU, MPU or the like).

Accordingly, since a computer implements the processing functions of the present invention, the program code supplied to and installed in the computer itself also achieves the present invention. In other words, the computer program for implementing the functional processes of the invention is itself also

Examples of storage media that can be used for supplying the program are magnetic storage media such as a floppy disk, a hard disk, or magnetic tape, optical/magneto-optical storage media such as an MO, a CD-ROM, a CD-R, a CD-RW, a DVD-ROM, a DVD-R, or a DVD-RW, and a non-volatile semiconductor memory or the like.

As for the method of supplying the program using wire/wireless communications, there is, for example, a method in which a data file (program data file), either a computer program itself that forms the invention or a file or the like that is compressed and automatically installed, and capable of becoming the computer program that comprises the invention on a client computer, is stored on a server on a computer network, and the program data file is downloaded to a connected client computer. In this case, the program data file may be divided into a plurality of segment files and the segment files distributed among different servers.

In other words, a server device that provides program data files to client computers for implementing the invention is also covered by the claims of the present invention.

Besides the cases in which the aforementioned functions according to the embodiments are implemented by a computer executing the read program, an operating system or the like running on the computer may perform all or a part of the actual processing based on the instructions of that program, so that the functions of the foregoing embodiments can be implemented by this processing.

Furthermore, after the program read from the storage medium is written to a function expansion board inserted in the computer or to a memory provided in a function expansion unit connected to the computer, a CPU or the like mounted on the function expansion board or function expansion unit may perform all or a part of the actual processing, so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-077669, filed on Mar. 17, 2005, which is hereby incorporated by reference herein in its entirety.

What is claimed is:

1. An electronic device comprising:
storage unit adapted to store instruction manual data;
display control unit adapted to read instruction manual data from the storage unit and displaying an instruction manual on a display device;
editing unit being capable of editing the instruction manual displayed on the display device; and
operating unit adapted to operate the display control unit and the editing unit.

2. The electronic device according to claim 1, wherein the instruction manual explains operation of the electronic device and a detachable accessory of the electronic device.

3. The electronic device according to claim 1, whereon the display device has a mode for displaying the instruction manual and a mode for displaying and editing the instruction manual on the display device.

4. The electronic device according to claim 1, wherein the editing unit is capable of adding a mark for indexing a character string or an item selected from the instruction manual.

5. The electronic device according to claim 1, wherein the editing unit further is capable of changing the appearance of a character string or an item selected from the instruction manual.

6. The electronic device according to claim 5, wherein the change of appearance includes at least one of a display/non-display change, a character or background color change, and a font change.

7. The electronic device according to claim 1, wherein the editing unit is capable of erasing a character string or an item selected from the instruction manual.

8. The electronic device according to claim 1, wherein the editing unit is capable of adding to or replacing an image in the instruction manual with at least one of a separate pre-prepared image and a newly created image.

9. The electronic device according to claim 1, wherein the editing unit is capable of adding a newly created character string to the instruction manual.

10. The electronic device according to claim 9, wherein the newly created character string is created with another electronic device.

11. The electronic device according to claim 1, wherein instruction manual data edited by the editing unit is stored in the storage unit.

12. An instruction manual editing method using an electronic device having storage means for storing instruction manual data, the electronic device reading the instruction manual data from the storage means and displaying the instruction manual on a display device in response to an operation of an operating means, and editing the instruction manual displayed on the display device in response to the operation of the operating means.

13. A computer program used in an electronic device having storage means for storing instruction manual data, the computer program causing a computer to execute:
a display process of reading instruction manual data from the storage means and displaying the instruction manual on a display device in response to an operation of an operating means; and
an editing process of editing the instruction manual displayed on the display device in response to the operation of the operating means.
